(19) United States
(12) Patent Application Publication
(10) Pub. No.: US 2018/0347553 A1
(43) Pub. Date: Dec. 6, 2018

(54) DOUBLE-ACTING PNEUMATIC PUMP

(71) Applicant: STPAPE CO., LTD., Kaohsiung City (TW)

(72) Inventor: SHENG-CHUNG LEE, KAOHSIUNG CITY (TW)

(21) Appl. No.: 15/613,572

(22) Filed: Jun. 5, 2017

(51) Int. Cl. F04B 5/02; F04B 49/22; F16K 11/02

(52) U.S. Cl. CPC F04B 5/02; F16K 11/02; F04B 49/225

(57) ABSTRACT

A double-acting pneumatic pump is disclosed herein. It comprises a main body; three partitions including a first partition dividing the main body into two chambers, and a second partition and a third partition respectively disposed at the opposite ends of the two chambers divided by the first partition; a piston rod inserted into the first partition disposed between the two chambers and having a first piston and a second piston at two ends thereof arranged in the two chambers respectively; a switching valve and an air flow valve sequentially connected to inlets of the first partition by pipelines; and a plurality of working pipes respectively connected to each of inlets and outlets of the second partition and the third partition.

### BACKGROUND OF THE INVENTION

### 1. Field of the Invention

The present invention relates to a double-acting pneumatic pump which can output the fluid at two different areas at one time and adjust the delivering frequency and the flow rate of the fluid flexibly.

### 2. Description of Related Art

A pump mainly consists of an engine body, a motor, blades and the like. The motor is disposed on one side of the engine body and connected to a driving shaft passing through the engine body for connection to the blades in the engine body. When the motor is actuated, the fluid flows from an inlet on one side of the engine body into the inside of the engine body, and the fluid further output from an outlet of the engine body when the blades work to pressurize the fluid. Accordingly, the pump can increase the delivery pressure of the fluid and drive it to move from a low place towards a high place.

However, there are many disadvantages of the conventional pump that needs to be solved. For instance, the conventional pump relies on the centrifugal force of the blades driven by the motor to cause driving force of the fluid. To obtain the centrifugal force required to pressurize the fluid, the motor must be maintained at a high rotational speed, resulting in consuming much energy and wearing down the components. Furthermore, the increased temperature inside the pump may damage to fluid quality. If rotational speed of a motor of a pump is reduced to slow down the pump damage rate and damage to the fluid quality, the pump may lose its function because the low rotational speed cannot drive the blades to produce enough centrifugal force for pushing the fluid. Accordingly, the conventional pumps are only suitable for the high speed delivery fluid, the fluid with lower requirement for fluid quality, and the single fluid delivery, but not suitable for the slow speed delivery of viscous fluid and multiple fluids delivery.

### SUMMARY OF THE INVENTION

In view of the above-mentioned problems, the object of the present invention is to provide a double-acting pneumatic pump which can output the fluid at two different areas at one time and adjust the delivering frequency and the flow rate of the fluid flexibly.

Disclosed herein is a double-acting pneumatic pump. It comprises:

a hollow main body;

at least three partitions for dividing the main body into at least two chambers, wherein one of the at least three partitions is disposed between the at least two chambers and bored with a through hole in the middle thereof; and

a piston rod disposed through the through hole and having a first piston and a second piston at two ends thereof respectively arranged in the at least two chambers, wherein each of a second partition and a third partition is bored with at least one inlet and at least one outlet at two ends thereof.

According to an embodiment of the present invention, the at least two chambers include a first chamber and a second chamber; and the at least three partitions include a first partition disposed between the first chamber and the second chamber and include at least two inlets therethrough for respective communication with the first chamber and the second chamber, the second partition and the third partition respectively disposed as an end wall of the first chamber and the second chamber at the other end from the first partition, and wherein the second partition has the at least one inlet therethrough for communication with the first chamber and the second chamber and the at least one outlet at the other end from the at least one inlet for communication with the first chamber, and the third partition has the at least one inlet therethrough for communication with the second chamber and the at least one outlet at the other end from the at least one inlet for communication with the second chamber.

According to an embodiment of the present invention, the double-acting pneumatic pump further comprises a plurality of working pipes, each having a check valve for respectively connecting to each of the at least one inlet and the outlet of the second partition and the third partition.

According to an embodiment of the present invention, the double-acting pneumatic pump further comprises a switching valve connected to each of the inlets of the first partition by a pipeline.

According to an embodiment of the present invention, the double-acting pneumatic pump further comprises an air flow valve connected to the switching valve by a pipeline.

According to an embodiment of the present invention, the switching valve is a two-position four-way reversing valve.

Accordingly, the switching valve of the double-acting pneumatic pump can actuate the first piston and the second piston in the two chambers to pressurize and output a fluid from the two chambers, so the present invention can output the fluid at two different areas at one time. By adjusting the valve positions of the switching valve to switch the frequency, the delivering frequency of the fluid in the chambers can be easily and accurately controlled. Furthermore, the air flow valve can control the output of high pressure air, and thus control the feed rate of the first piston and the second piston, so the present invention achieves the effects of adjusting the flow rate of the fluid flexibly.

### BRIEF DESCRIPTION OF THE DRAWINGS

FIG. 1 is a cross-sectional diagram showing a double-acting pneumatic pump according to the present invention;

FIG. 2 is a cross-sectional diagram showing a double-acting pneumatic pump in use according to the present invention.

### DETAILED DESCRIPTION OF THE PREFERRED EMBODIMENT

Hereinafter, an exemplary embodiment of the present invention will be described in detail with reference to the accompanying drawings.

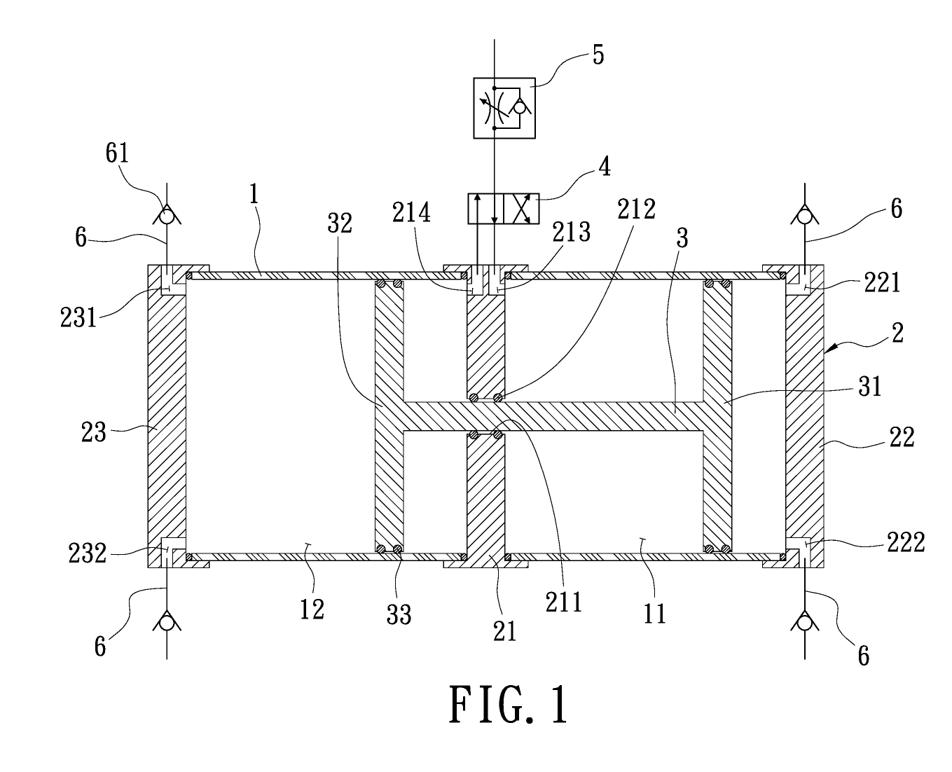

As showed in FIG. 1, a cross-sectional diagram showing a double-acting pneumatic pump according to the present invention is disclosed. The double-acting pneumatic pump comprises:

a hollow main body (1);

at least three partitions (2) for dividing the main body (1) into at least two chambers, wherein one of the at least three partitions (2) is disposed between the at least two chambers; preferentially, the at least two chambers include a first chamber (11) and a second chamber (12), and the at least three partitions (2) include a first partition (21) disposed between the first chamber (11) and the second chamber (12) and bored with a through hole (211) in the middle thereof, a second partition (22) and a third partition (23) respectively disposed as an end wall of the first chamber (11) and the second chamber (12) at the other end from the first partition (21); and

a piston rod (3) disposed through the through hole (211) and having a first piston (31) and a second piston (32) at two ends thereof respectively arranged in the first chamber (11) and the second chamber (12).

The distance between the first partition (21) and the second partition (22) of the first chamber (11) and the distance between the second partition (22) and the third partition (23) of the second chamber (12) are the movement range of the first piston (31) and the second piston (32), respectively. The first piston (31) and the second piston (32) are further provided with at least one leakproof gasket (33) at two ends thereof for contact with peripheral walls of the first chamber (11) and the second chamber (12). A hole wall of the through hole (211) of the first partition (21) is also provided with at least one leakproof gasket (212) for contact with the piston rod (3). The first partition (21) disposed between the first chamber (11) and the second chamber (12) includes two inlets (213) (214) therethrough for respective communication with the first chamber (11) and the second chamber (12). The double-acting pneumatic pump further comprises a switching valve (4) connected to each of the two inlets (213) (214) by a pipeline, and preferentially the switching valve (4) is a two-position four-way reversing valve. The double-acting pneumatic pump further comprises an air flow valve (5) connected to the switching valve (4) by a pipeline. Each of the second partition (22) and the third partition (23) is bored with at least one inlet (221) (231) and at least one outlet (222) (232) at two ends thereof The second partition (22) has the at least one inlet (221) therethrough for communication with the first chamber (11) and the at least one outlet (222) at the other end from the at least one inlet (221) for communication with the first chamber (11), and the third partition (23) has the at least one inlet (231) therethrough for communication with the second chamber (12) and the at least one outlet (232) at the other end from the at least one inlet (231) for communication with the second chamber (12). Each of the inlets (221) (231) and the outlets (222) (232) of the second partition (22) and the third partition (23) is connected with a working pipe (6), and the working pipe (6) is further provided with a check valve (61). The check valves (61) of the working pipes (6) disposed on the inlets (221) (231) of the second partition (22) and the third partition (23) respectively prevent the fluid flowing into the first chamber (11) and the second chamber (12) from countercurrents, and the check valves (61) of the working pipes (6) disposed on the outlets (222) (232) of the second partition (22) and the third partition (23) respectively prevent the fluid output from the first chamber (11) and the second chamber (12) from countercurrents.

Accordingly, in use of the double-acting pneumatic pump, the air flow valve (5) is connected to an air compressor, and the switching valve (4) and the air flow valve (5) are coupled to a control unit, so the control unit can adjust the valve position of the switching valve (4) to switch the frequency and adjust air flow by the air flow valve (5). In such a case, the check valves (61) of the working pipes (6) on the inlets (221) (231) of the second partition (22) and the third partition (23) can respectively prevent a first fluid in the first chamber (11) and a second fluid in the second chamber (12) from countercurrents.

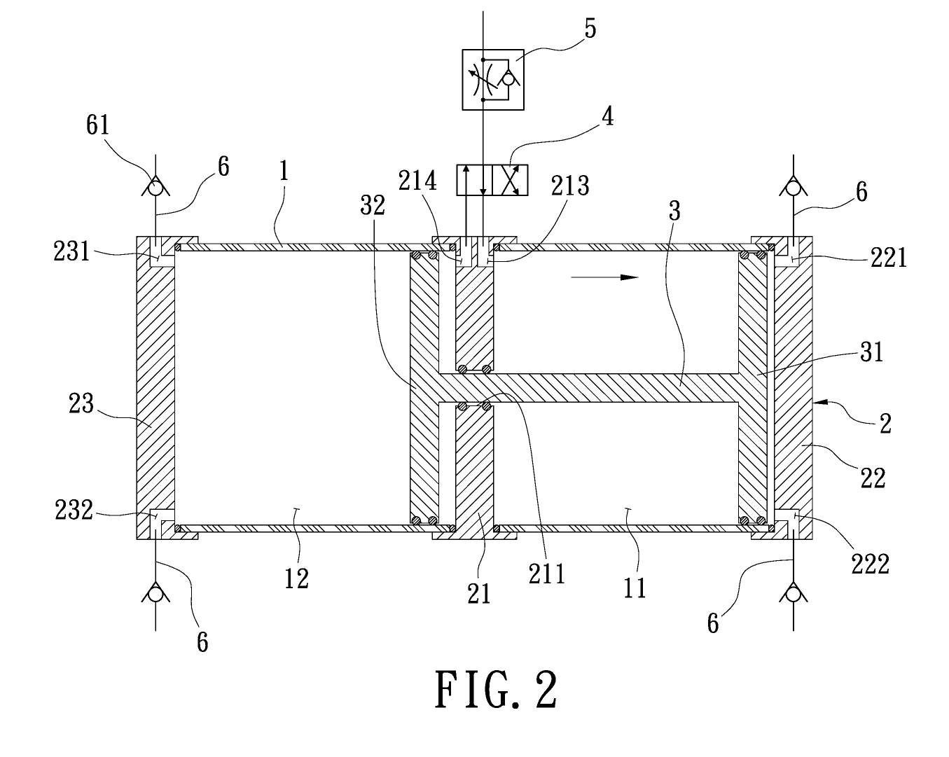

Referring to FIG. 2, a cross-sectional diagram showing a double-acting pneumatic pump in use according to the present invention is disclosed. To pressurize and output a first fluid in the first chamber (11), a switching valve (4) is actuated by a control unit to switch to the first valve position. In such a case, high pressure air output from the air compressor is driven to pass through the inlet (213) of the first partition (21) and flow into the first chamber (11) under guidance of the first valve position of the switching valve (4), and thus the first piston (31) in the first chamber (11) moves towards the second partition (22), which pushes the first fluid in the first chamber (11) flowing into the outlet (222) of the second partition (22) and outputting from the working pipe (6). The check valve (61) of the working pipe (6) can prevent the fluid output from the outlet (222) of the second partition (22) from flowing back into the first chamber (11).

In addition, to pressurize and output a second fluid in the second chamber (12), the switching valve (4) is actuated by a control unit to switch to the second valve position. In such a case, high pressure air output from the air compressor is driven to pass through the inlet (214) of the first partition (21) and flow into the second chamber (12) under guidance of the second valve position of the switching valve (4), and thus the second piston (32) in the second chamber (12) moves towards the third partition (23), which pushes the second fluid in the second chamber (12) flowing into the outlet (232) of the third partition (23) and outputting from the working pipe (6). The check valve (61) of the working pipe (6) can prevent the fluid output from the outlet (232) of the third partition (23) from flowing back into the second chamber (12).

Accordingly, the double-acting pneumatic pump of the present invention can output the first fluid as well as the second fluid at two different areas at one time. Furthermore, different arrangements of the working pipes (6), the outlets (222) (232) and the inlets (221) (231) of the second partition (22) and the third partition (23) can provide different work efficiency. For instance, the fluid can flow back and forth in the first chamber (11) and the second chamber (12) if the outlet (222) and the inlet (221) of the second partition (22) are respectively connected to the inlet (231) and the outlet (232) of the third partition (23) by the working pipes (6). By adjusting the first valve position and the second valve position of the switching valve (4) to switch the frequency, the delivering frequency of the fluid respectively pressurized by the first piston (31) and the second piston (32) in the first chamber (11) and the second chamber (12) can be easily and accurately controlled. The air flow valve (5) can control the output of high pressure air, and thus control the feed rate of the first piston (31) and the second piston (32). Therefore, the present invention achieves the effects of adjusting the delivering frequency and the flow rate of the fluid flexibly and is suitable for delivering various fluid with different viscosities. When the double-acting pneumatic pump of the present invention is used for fluid exchange in a closed pipe or in a chamber, the first piston (31) and the second piston (32) are driven to move in the same volume space of the first chamber (11) and the second chamber (12) by the piston rod (3). In such a case, the present invention ensures the flow volume, the flow rate and the pressure of the fluid extracted or delivered in the first chamber (11) to keep equal to those of the second chamber (12) and prevents occurrence of negative pressure in the closed pipe or the chamber, so accuracy and security of fluid exchange in a closed pipe or in a chamber are increased.

Compared with the technique available now, the present invention has the following advantages:

1. The present invention having at least two chambers, each having a piston therein and the pistons connected by a piston rod, can pressurize the fluid to output from the chambers by driving the pistons in every chambers, which achieves efficacy of outputting the fluid at two different areas at one time.

2. The present invention has the first chamber and the second chamber with the same volume space and has the piston rod to drive the pistons in the two chambers to move, which ensure the flow volume, the flow rate and the pressure of the fluid extracted or delivered in the first chamber to keep equal to those of the second chamber and prevent occurrence of negative pressure in the closed pipe or the chamber, so accuracy and security of fluid exchange in a closed pipe or in a chamber are increased

3. The present invention can control the delivering frequency of the fluid in the chambers easily and accurately by adjusting the valve positions of the switching valve to switch the frequency. Furthermore, the air flow valve can control the output of high pressure air, and thus control the feed rate of the first piston and the second piston, so the present invention achieves the effects of adjusting the flow rate of the fluid flexibly and is suitable for delivering various fluid with different viscosities.

4. The present invention can effectively prevent damage to fluid quality due to high temperature generated by injection and output the fluid of the chambers, so it is also suitable for delivering the fluid with higher requirement for fluid quality.

What is claimed is:

1. A double-acting pneumatic pump, comprising:
a hollow main body;
at least three partitions for dividing the main body into at least two chambers, wherein one of the at least three partitions is disposed between the at least two chambers and bored with a through hole in the middle thereof; and
a piston rod disposed through the through hole and having a first piston and a second piston at two ends thereof respectively arranged in the at least two chambers, wherein each of a second partition and a third partition is bored with at least one inlet and at least one outlet at two ends thereof.

2. As the double-acting pneumatic pump claimed in claim 1, wherein the at least two chambers include a first chamber and a second chamber; and the at least three partitions include a first partition disposed between the first chamber and the second chamber and include at least two inlets therethrough for respective communication with the first chamber and the second chamber, the second partition and the third partition respectively disposed as an end wall of the first chamber and the second chamber at the other end from the first partition, and wherein the second partition has the at least one inlet therethrough for communication with the first chamber and the at least one outlet at the other end from the at least one inlet for communication with the first chamber, and the third partition has the at least one inlet therethrough for communication with the second chamber and the at least one outlet at the other end from the at least one inlet for communication with the second chamber.

3. As the double-acting pneumatic pump claimed in claim 2, wherein the double-acting pneumatic pump further comprises a plurality of working pipes, each having a check valve, for respectively connecting to each of the at least one inlet and the at least one outlet of the second partition and the third partition.

4. As the double-acting pneumatic pump claimed in claim 2, wherein the double-acting pneumatic pump further comprises a switching valve connected to each of the inlets of the first partition by a pipeline.

5. As the double-acting pneumatic pump claimed in claim 4, wherein the double-acting pneumatic pump further comprises an air flow valve connected to the switching valve by a pipeline.

6. As the double-acting pneumatic pump claimed in claim 4, wherein the switching valve is a two-position four-way reversing valve.
